(19) United States
(12) Patent Application Publication
(10) Pub. No.: US 2002/0070973 A1
(43) Pub. Date: Jun. 13, 2002

(54) Method of entering, updating and display of related data on a single screen page

(76) Inventor: James E. Croley, Cape Coral, FL (US)

Correspondence Address: MELVIN K. SILVERMAN, SUITE 440, 4901 NORTH FEDERAL HIGHWAY, FORT LAUDERDALE, FL, 33308, US

(21) Appl. No.: 09/933,739

(22) Filed: Aug. 22, 2001

Related U.S. Application Data
(63) Continuation-in-part of application No. 09/046,490, filed on Mar. 23, 1998, now abandoned.

(51) Int. Cl. G09G 5/00

(52) U.S. Cl. 345/780

(57) ABSTRACT

A method of entering, updating and displaying of related data includes the steps of configuring a data form, intended for real time use during an examination or technical inspection, into a geometry to display its entirety upon a single screen page of computer monitor; providing a plurality of WINDOWS-based reference menus in which potential alpha-type entries for each of a subset of data fields are dynamically linked to the reference menus; and selectably entering data from the menus into corresponding data fields of the form. Entries of designated key default fields are stored for later display on new forms for subsequent generations of examinations and inspections.

### REFERENCE TO RELATED APPLICATION

This is a continuation-in-part of application Ser. No. 09/046,490, filed Mar. 23, 1998, entitled Method of Entering, Updating and Displaying of Spatially Related Data.

### BACKGROUND OF THE INVENTION

1. Field of Invention

The present invention relates to the computerized use of forms of a type typically used by a doctor during the course of a medical examination, and to methods of entering and updating data and data fields of such forms, and displaying the same as a Single screen page.

2. Prior Art

A problem with respect to data entry upon standardized forms is that the size and shape of the form is often such that the entire form cannot be displayed upon a single screen page of a computer monitor. As such, when entry and display of information to such a form is required in substantially real time, as is the case during a medical examination, or field operations such as technical inspections, it has, in the prior art, been necessary to scroll between different screens to access that data field of a given form for which data is being generated or is needed at that time, or for which data must be entered or available at a particular point during an examination. As such, it is not, as a practical matter, possible to accomplish real time data entry to medical forms where the form, due to either its length or geometry, is unsuited for display upon a single screen page. Also, as noted above, to best use many medical and other forms, it is necessary to observe information or fields of information, from one part of that form to properly enter information upon a different part of the form, or to access a database. As such, if the entire form is not visible on a single screen page, efficient data entry is not possible and use of such a form cannot be practically accomplished during the medical procedure or technical field inspection.

An additional limitation of prior art medical and other forms, in which real time entry of data is contemplated, is that there does not exist any multiple-choice means for selection of types of information to be typed out in phrase or other form upon a given form. In other words, even though alpha type entries, that is, word and phrase information to be entered within a particular data field of a medical form is, in many cases, highly standardized and selectable from a set typically not exceeding ten possible entries, there does not exist any form of entry means through which selection by “clicking” upon a multiple choice box will result in automatic entry by the software of an entire phrase or sentence reflective of historical patient or project-related information to be entered by a user within a given data field, e.g., a blank square or rectangle of the form.

It is in response to this long-felt need in the art, for a single screen page display and simple to utilize, real time usable form having dynamically linked key and non-key default fields to a plurality of WINDOWS-based reference menus, that the present invention is directed.

Applicable prior art known to the inventor consists of U.S. Pat. No. 4,763,356 (1988) to Day et al, and U.S. Pat. No. 5,325,428 (1994) to Shelton et al.

The patent to Day does not specifically teach the display of an entire data form upon a single screen page; rather, Day it that such a form must occupy at least two pages. Day contains no teaching relative to reconfiguration of data fields to fit onto a single screen page. As noted, the use of a single screen form without requirement for scrolling or alternation between pages thereof, for purposes of data entry, constitutes the essential rationale for the invention, since the same is a requirement for persons such as physicians and inspectors at remote or hostile locations having only a laptop or Powerpad to work with. As such, Day does not address the issue of configuration or reconfiguration of a data form for purposes of viewing the entirety thereof upon a single screen page.

Said patent to Shelton teaches a method of “consolidating information from various object instances into a single form.” However, that function is very different than that addressed herein. That is, Shelton does not make any reference to consolidation of information to produce a form for the display of the entirety thereof upon a single screen page. Rather, Shelton speaks only in terms of the consolidation of selectable existing information from various other forms and external sources into a single form, but not into a form of a single page. As such, the within invention is not one of consolidating information from external forms or databases but, rather, is concerned with data entry, in real time, during a clinical examination or inspection procedure, or by an engineer in a remote or hostile environment. Thereby, neither Sheldon nor Day teach a method by which a multi-page form can be configured for viewing upon a single screen page, or a single form always viewed on one page. As above noted, Shelton speaks in term of a single form, not a form comprising use of a single page. Therein, Shelton contains no suggestion with respect to the size, geometry, or number of pages of its resultant “single form.” That is, a single form is created, without any particular concern regarding the size, shape, or number of pages thereof. Such a system is not intended for real-time clinical use, and is more properly termed an automated records management system.

Also, the prior art as reflected in Day uses read-only fields that contain data or entries that never change. This is not the case with default fields based on prior examinations or inspections. Data entries of such default fields may therefore be dynamic, not static or fixed entries, comprising data that changes over the history of a physician-patient relationship which, in the case of certain medical specialties such as ophthalmology, can extend over many years. Therefrom, it may be appreciated that changes in default field information, or the correction of errors thereof, is anticipated in the instant system, whereas in that of Day the data of such default fields is entirely static and cannot be easily changed by a user of the system. As such, the default fields of Day are not dynamically linked to any WINDOWS-based reference menu, as in the method of this invention.

### SUMMARY OF THE INVENTION

A method of entering, updating, and displaying of related data on a single screen page, the method includes the steps of configuring a data form intended for real time use, during a physical examination or technical inspection, into a geometry sufficient to display the entirety thereof upon a single screen page of a computer monitor; providing a plurality of WINDOWS-based reference menus including potential alpha-type entries for a plurality of data fields at least partially defining said data form; providing, as an adjunct to a subset of said data fields and means, a multiple choice menu of click-enterable alpha-type WINDOWS-based reference entries in which said subset of data fields are dynamically linked thereto; selectably entering data for at least said subset of fields, from said reference menus into said data fields of said forms; storing each completed data form corresponding to an examination or inspection, thereby defining an historical data form; designating said certain data fields thereof as key default fields; and displaying upon said single screen of said computer monitor all data entries of at least said key default fields of each historical form of each preceding examination or inspection, or prior to said entering step above.

It is accordingly an object of the present invention to provide a real time method of entry of information upon a software form occupying no more than a single computer monitor screen.

It is another object to provide a cost-efficient method of real time entry of medical and other technical information upon a single screen form without requirement of keystroke entry of most alpha type categories of entries to be made to such form.

It is a further object of the invention to provide a method of entering alpha and graphic data in which historic data fields of the form can be viewed or retrieved at the same time by a system user.

It is a yet further object to provide a method of the above type in which a real time, single screen form can be updated without requirement to re-enter key data or information that has not changed since the preceding examination or inspection.

The above and yet other objects and advantages of the present invention will become apparent from the hereinafter set forth Brief Description of the Drawings, Detailed Description of Invention and Claims appended herewith.

### BRIEF DESCRIPTION OF THE DRAWINGS

FIG. 1 is a flow diagram showing a first part of the inventive software program.

FIG. 2 is a flow diagram showing a second part thereof.

FIG. 3 is a flow diagram showing a third part thereof.

FIG. 4 illustrates a form in accordance with the present invention adapted for display upon a single screen of a computer monitor.

FIG. 5 shows the form of FIG. 4, however, with a WINDOWS menu for a “patient complaint” category.

FIG. 6 shows the appearance of the form of FIG. 4 after a user has clicked the “classes re-check” line shown in FIG. 4.

FIG. 7 is a further view of the form of FIG. 4, after a physician user has clicked upon a WINDOWS menu pertaining to available types of ophthalmologic medication.

FIG. 8 is a view of the form of FIG. 4 after a physician user has clicked upon a WINDOWS menu for information relative to present and historic contact lens data of the patient.

FIG. 9 is a view of the form of FIG. 4 which permits a doctor to make graphic annotations for purposes of storage in memory with the subject form, relative to the optical conditions of a patient regarding specific locations within the optics of the problems observed by the doctor.

### DETAILED DESCRIPTION OF THE INVENTION

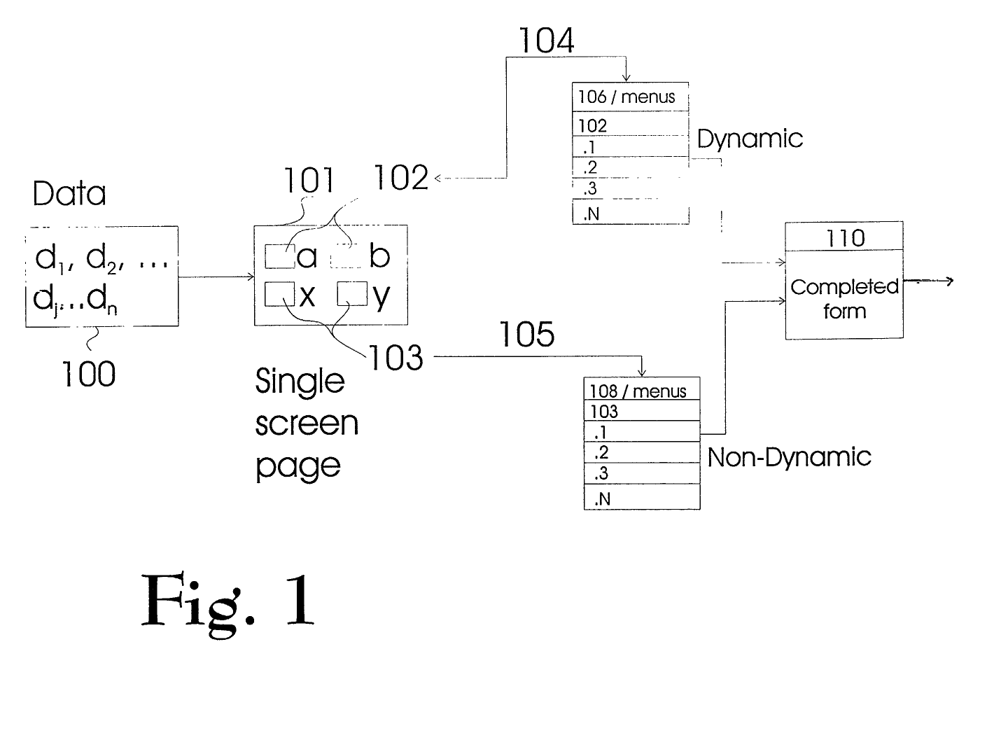

With reference to FIG. 1, a plurality of medical or other technical data 100 (d₁, d₂, . . . dⱼ, . . . dₙ) are employed to configure a data form 101, of a type intended for real time use during a physical examination or technical inspection, into a geometry sufficient to display the entirety thereof upon a single screen page of a computer monitor. Said form comprises data field types 102 and 103 having therein data a, b, . . . xy. There is further provided a plurality of WINDOWS-based reference menus 106 and 108, each including potential alpha-type entries for each of said types of data fields 102, and 103 which define the single screen page form 101. Certain of said data fields, namely, data fields 102 are provided with a multiple-choice menu of click-enterable alpha-type entries 106.1, 106.2, . . . 106.N. These alpha-type entries are dynamically linked (via line 104) to said data fields 102.

With reference to the other data fields, namely, the 103 fields, these may via line 105) be provided with a WINDOWS based reference menus 108 which, however, are not dynamically linked to said data fields 103. The double arrow at each end of line 104 indicates the dynamic nature of that linkage, whereas single arrow line 105 indicates that data fields 103 are non-dynamically linked to the menus 108 associated therewith. A completed data form 110 is thereby formed.

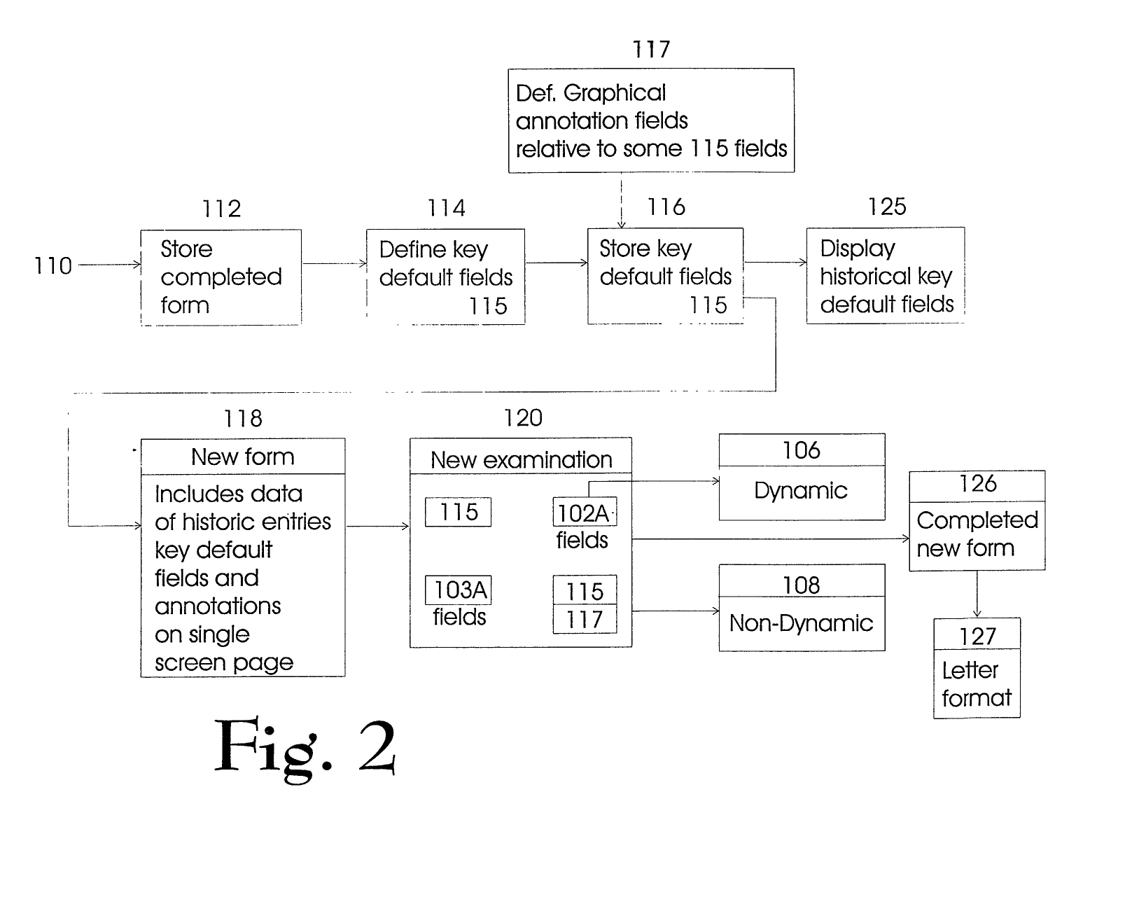

As is indicated in FIG. 2, each completed data form 110 which corresponds to a medical examination, procedure or a technical inspection, is thereby stored (see block 112). During storage, certain data fields are designated key default fields 115 (see block 114) and stored as such, as is indicated at block 116 of the flow diagram. As an important option of the instant system, graphical annotations may be defined for use with a WINDOWS based supplemental data field 117 which is dynamically linked to corresponding key default fields 115.

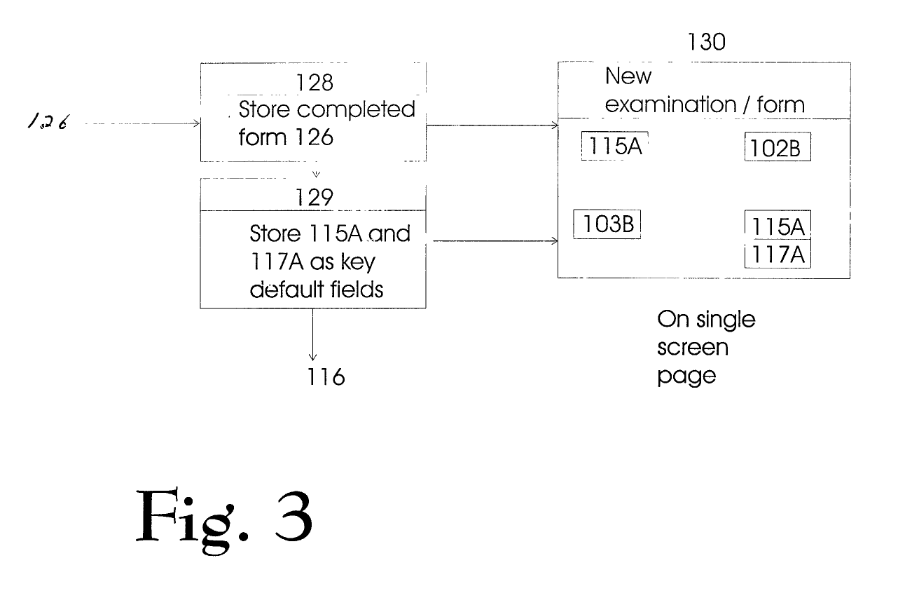

The output of this process is configured into a new form 118 which is employed upon the next examination, procedure or examination, and retains the original single screen page, size and geometry as that of the original data form 101. Thereby, a unique level of convenience is afforded to the physician or technician (for example, one with a wireless Powerpad in a remote or hostile location), which includes all relevant historical data from the key default fields 115. This appears upon new form 118 as soon as it is retrieved from memory, and the geometry of such form removes any requirement for scrolling or searching through multiple pages or databases that might be otherwise needed to initiate an examination, procedure or inspection. As such, a new examination or procedure 120 can begin with key default fields 115 already on the screen, this together with dynamically linked graphical annotations 117 from prior examinations. Thereby, all that must be filled out are the data fields 1 02A that are dynamically linked to said WINDOWS-based reference menus 106 and data fields 103A that may be provided with reference menus 108 that are not dynamically linked to data fields 103A. The user receives historical alpha type and graphic type default field entries 115 and 117 from a historical form of the prior examination or inspection which may (or may not) be retained as an entry during the new examination or procedure 120. As another option, one may also access, from database 116, key default information from all historical examinations or inspections, this from a separate WINDOW-based menu or and display 125. Each completed newly form 126 may, if desired, be transposed into a format of a letter-type report 127 addressable to a third party, which form may then be printed for purposes of mailing, faxing, or hard copy storage by the user, or may be kept in data form and e-mailed, or simply stored in memory 128. Therein, key default fields are extracted into memory 129 and therefrom become a part of database 116. See FIG. 3. Therein is also shown a later generation form 130 which now includes thereon new fields 102B and 103B, as well as the most recently generated default fields 115A and 117A.

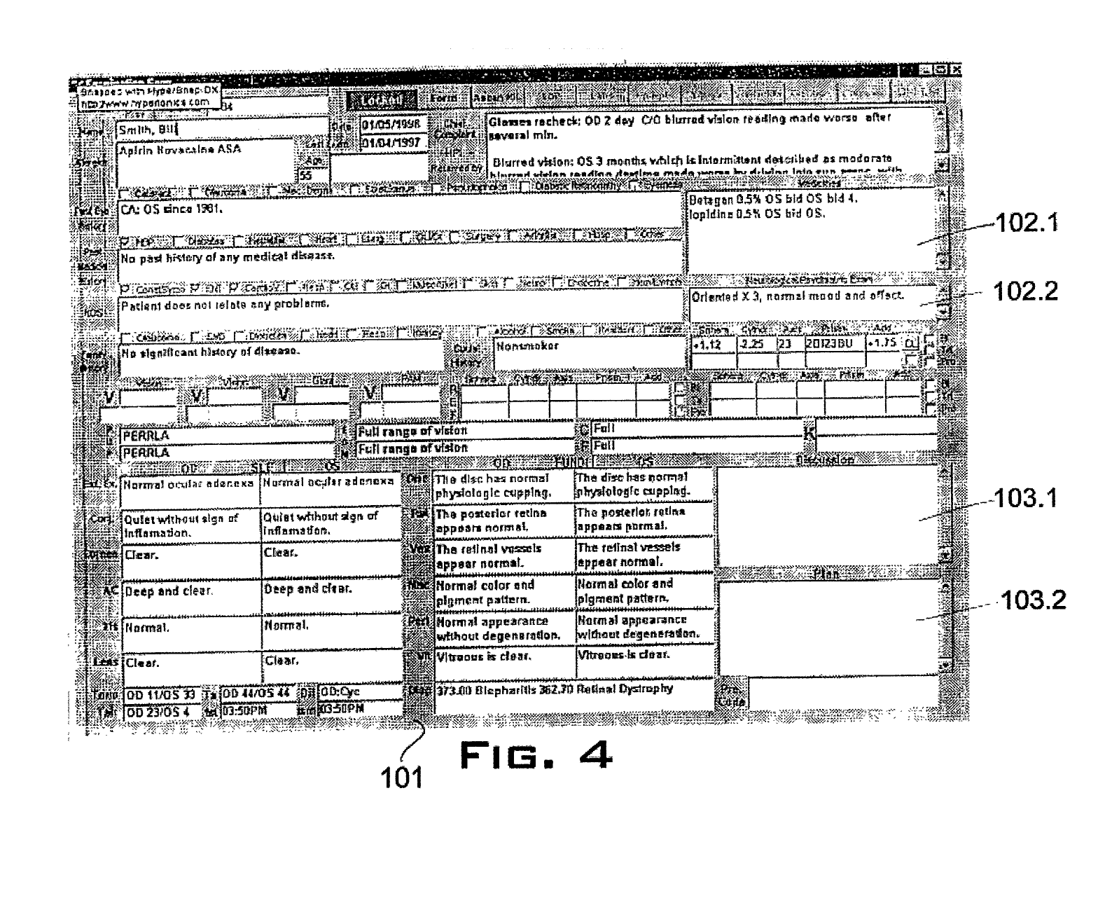

Reviewing the above in a clinical context, as an initial step in the inventive method, an original form 101 having no predecessor is formatted such that all essential data fields thereof, when expressed out of memory, will be displayed on a single screen of computer monitor. See FIG. 4. The invention is therefore applicable to forms of a type which are not practical or efficient to use in real time if one (including any assistant, such as a nurse) is unable to view all data fields at the same time. This is desirable, not only because of the inefficiency associated with any scrolling of a given form to view parts thereof not otherwise viewable upon a single screen but, as well, because, in many medical and technical forms, effective real time data entry cannot occur unless the operator is able to simultaneously view all data fields or, at least, all data fields for which alpha or manual entries are to be made.

In the event that a pre-existing form relative to the same desired information capture exists, and the form thereof is of size or geometry which is impractical to reduce to the size of the single screen of computer monitor, then such pre-existing form is, as the initial step in the instant method, reconfigured such that those data fields 102 and 103 must be simultaneously viewed during the examination or inspection, all appear upon a single screen. In general, a data form having an overall size of about 8 ½ by 11 inches, or the metric variant, thereof which is about 8×11 ½ inches (known as A4 size), will fit within a single screen of a conventional computer monitor.

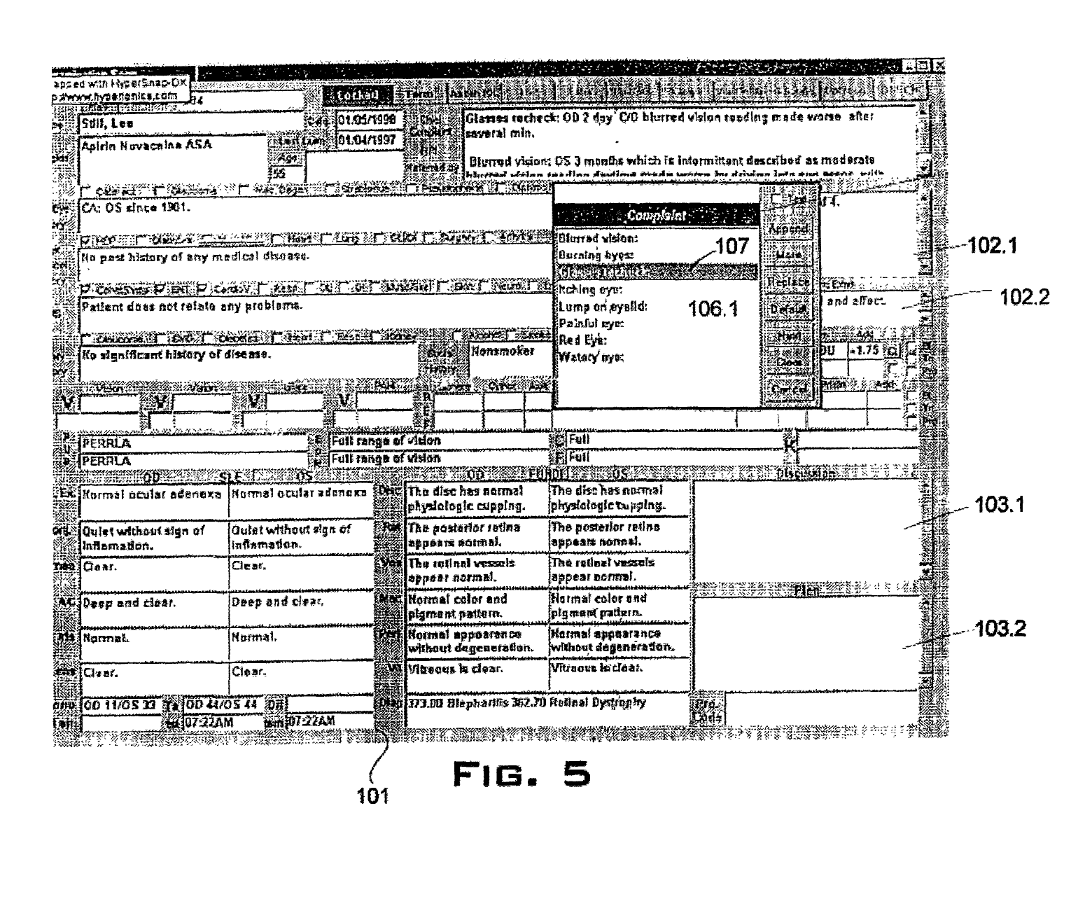

After the reconfigured data form 101 is created (see FIGS. 4 and 5), there may be accessed WINDOWS based reference menus 106.1 which comprise potential alpha type entries for each of the 102 type of data fields, e.g., fields 102.1 and 102.2 which define the data form 101. Thereafter, the user, using click entry means, will selectably enter at least one entry of menu 106.1 into data field 102.1 corresponding in subject matter to that menu. Therein, there is provided, as an adjunct to these data fields 102, dynamically linked multiple-choice menus of click-enterable alpha-type entries 107.

As a further and highly advantageous aspect of the instant system, every completed form is stored in computer memory 142 to create a historic record of the completed form. See FIG. 2. When a subsequent examination or inspection starts, the user can call up from memory 125 certain parts of the last completed historical form, and display upon the computer screen, namely, key default fields entries 115 of the predecessor form. That is, as above noted, certain of the data fields are, after original entry of information thereunto, designated by the program as said default fields 115, so that said fields are identically displayed upon call-up from memory 125 for purposes of any subsequent examination or inspection. As such, it is only necessary for a system user to re-enter data for those data fields which are not default fields, unless default field information is to be changed.

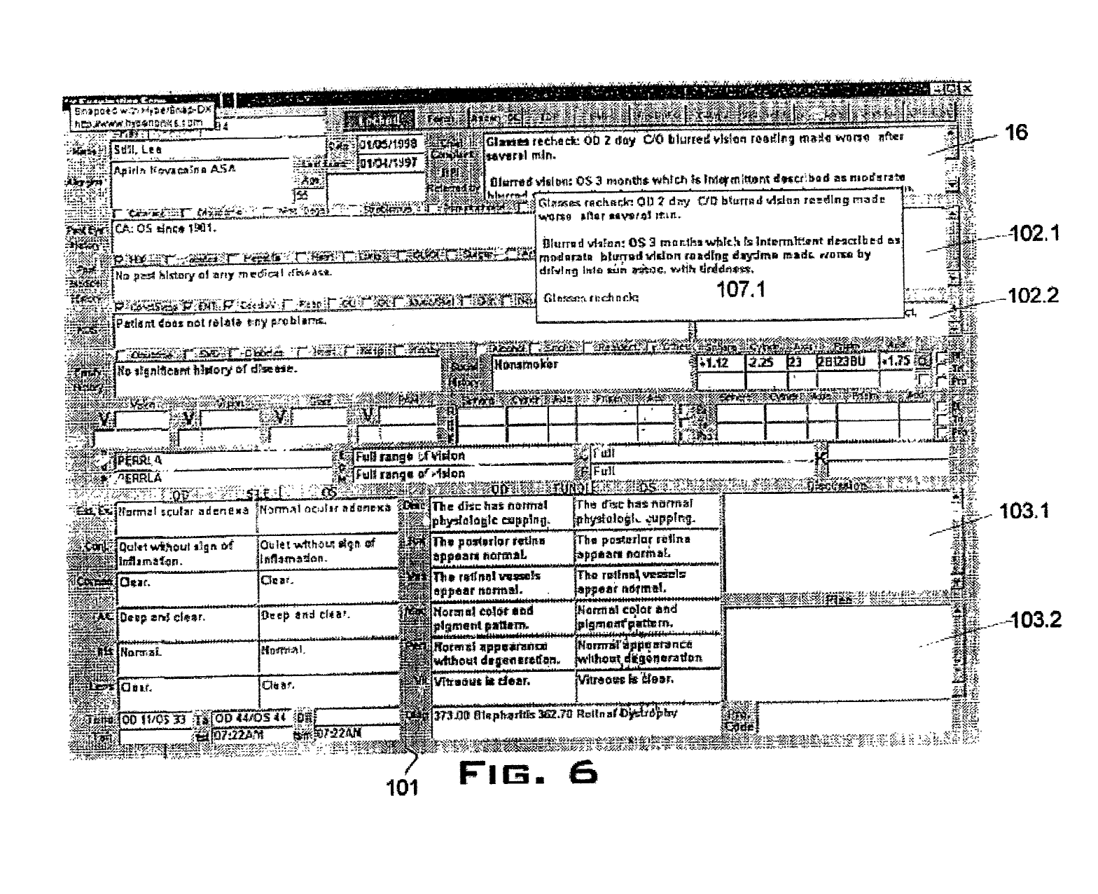

In FIG. 5 is shown an example of said WINDOWS based reference menu 106.1 which can be called up from memory by the user to assist in filling out data field 102.1. Therein, in the case of a medical application of the present invention, if the doctor (in this case, an ophthalmologist) chooses to click on entry 107 of menu 106.1, a WINDOW screen comprising sub-menu 107.1 (see FIG. 6) will appear, replacing menu 106.1 and providing to the doctor more detailed suggestions for information entry into data field 102.1. Therefrom the operator may, using click entry means, enter all or part of sub menu 107.1 into data field 102.1.

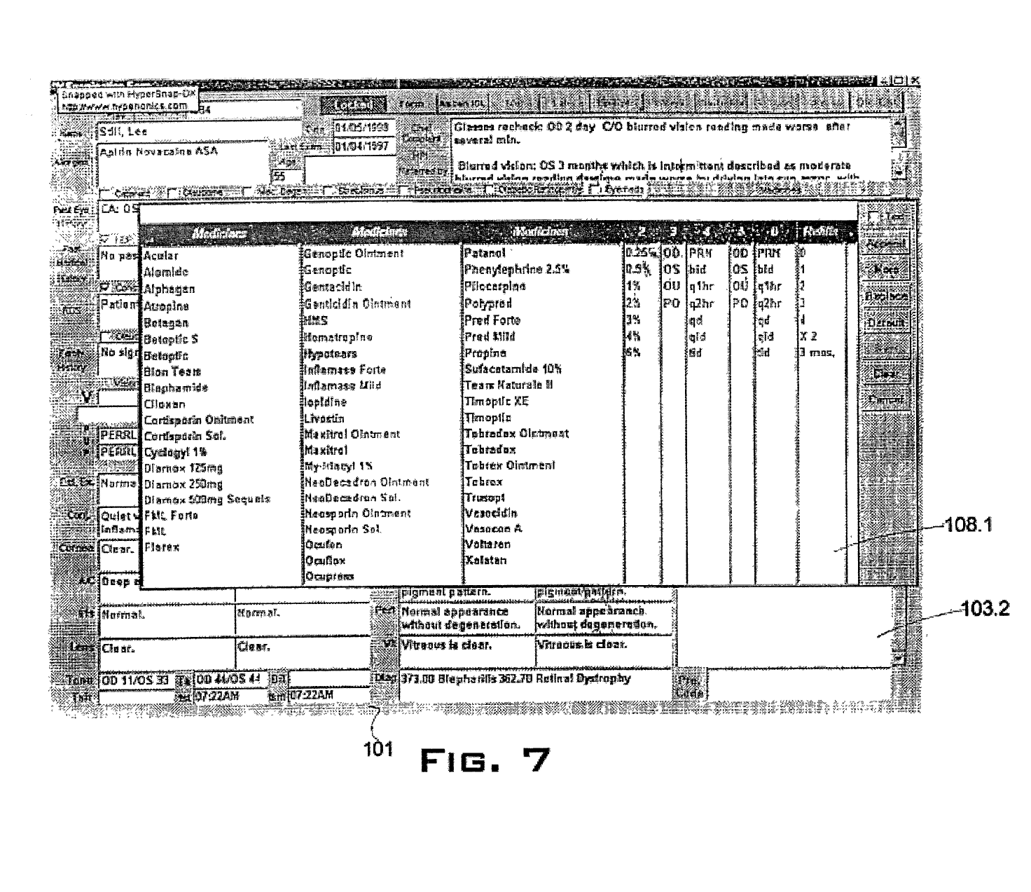

In FIG. 7 is shown a medication menu 108.1 which is used to provide ideas to the doctor relative to a treatment plan for the patient. Information thereof may, using click entry means, be entered into a data field 103.2 of form 101.

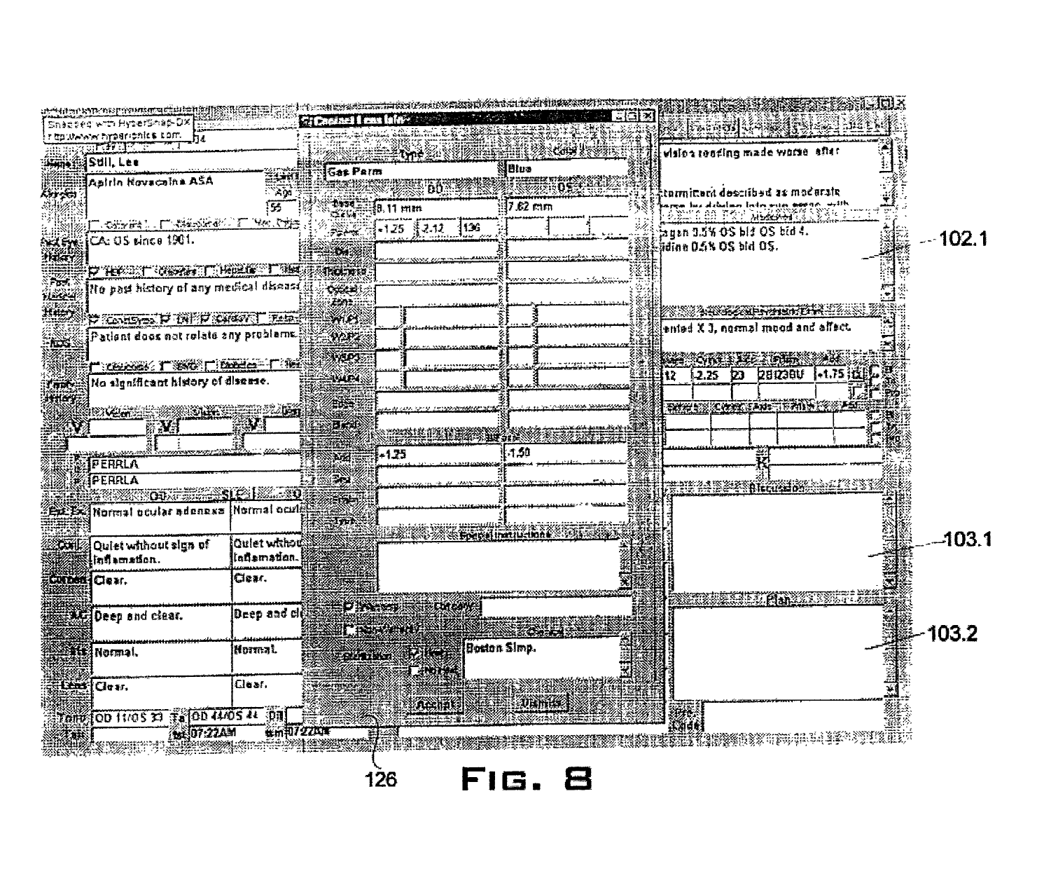

In FIG. 8 is shown said default field memory 125 which, in this application, contains historic information relative to contact lens user patients of the doctor. Such information, while purely historical in nature, is of value to the doctor in rendering appropriate entries to data field 103.1 which may be a field allocated to patient discussion.

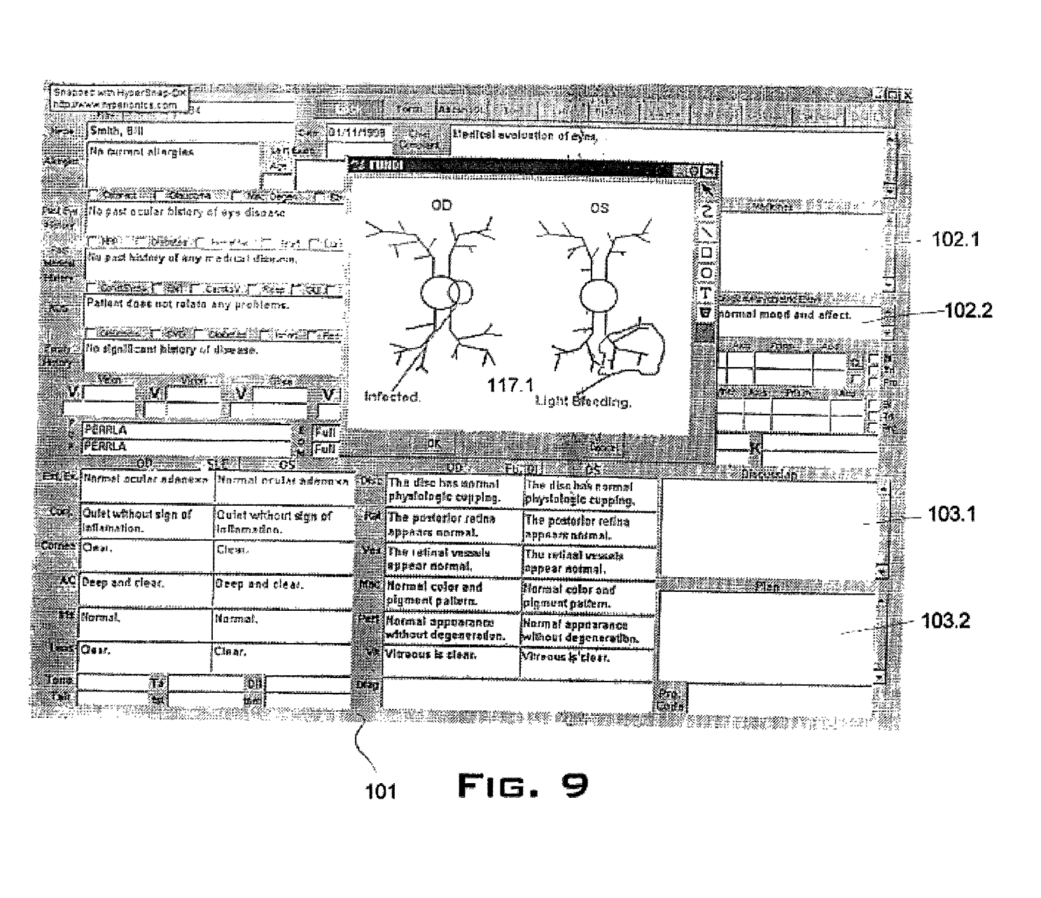

In FIG. 9 is shown said WINDOWS based supplemental data field 117.1 which provides to the doctor a means for recording graphical annotations relative to specific patient conditions that are subject to graphical representation as a schematic or icon corresponding to a particular physiology or condition.

In the present method there is further provided said software means 127 for transposing selected data entries of the fields of the data form into a format of (1) a letter-type report addressable to a third party such as a referring physician or governmental official, or (2) an e-mail format.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

Having thus described my invention what I claim as new, useful and non-obvious and, accordingly, secure by letters patent of the united states is:

1. A method of entering, updating, and displaying of related data on a single screen page, the method comprising the steps of:
(a) configuring a data form intended for real time use, during a physical examination or technical inspection, into a geometry sufficient to display the entirety thereof upon a single screen page of a computer monitor;
(b) providing a plurality of WINDOWS-based reference menus including potential alpha-type entries for a plurality of data fields at least partially defining said data form;
(c) providing, as an adjunct to a subset of said data fields and menus, a multiple choice menu of click-enterable alpha-type WINDOWS-based reference entries in which said subset of data fields are dynamically linked thereto;
(d) selectably entering data for at least said subset of fields, from said reference menus into said data fields of said forms;
(e) storing each completed data form corresponding to an examination or inspection, thereby defining an historical data form;
(f) designating said certain data fields thereof as key default fields; and
(g) displaying upon said single screen of said computer monitor all data entries of at least said key default fields of each historical form of each preceding examination or inspection, or prior to said entering Step (d) above.

2. The method as recited in claim 1, in which said Step (g) further comprises the step of:
dynamically linking said default fields to a plurality of WINDOWS-based reference menus corresponding to prior generations of examinations or inspections of the same person or subject matter.

3. The system as recited in claim 1, further comprising the step of:
transposing selected data entries of said data field into a format of a letter-type report addressable to a third-party; and
printing said report.

4. The method as recited in claim 1, further comprising the step of:
providing graphical annotations to a WINDOWS-based supplemental data field, dynamically linked to a subset of said key default fields.

5. The method as recited in claim 2, further comprising the step of: providing graphical annotations to a WINDOWS based supplemntal data field, said data field dynamically linked to said key default fields.

6. The method as recited in claim 1, in which said dynamically linked means include at least one dynamically linked sub menu.

7. A product of the method of claim 1.

8. A product of the method of claim 4.
